(19) United States
(12) Patent Application Publication
(10) Pub. No.: US 2025/0013917 A1
(43) Pub. Date: Jan. 9, 2025

(54) METHOD FOR CONTROLLING ARTIFICIAL INTELLIGENCE MODEL BASED ON ACCESS RIGHT, APPARATUS FOR THE SAME, COMPUTER PROGRAM FOR THE SAME, AND RECORDING MEDIUM STORING COMPUTER PROGRAM THEROF

(71) Applicant: Fasoo Co., Ltd., Seoul (KR)

(72) Inventor: Kyung Koo YOON, Gyeonggi-do (KR)

(21) Appl. No.: 18/397,422

(22) Filed: Dec. 27, 2023

(30) Foreign Application Priority Data
Jul. 7, 2023 (KR) 10-2023-0088090
Aug. 17, 2023 (KR) 10-2023-0107530

(51) Int. Cl. G06N 20/00

(52) U.S. Cl. CPC G06N 20/00

(57) ABSTRACT

A method and a device for performing access control based on an access right for an artificial intelligence (AI) model are disclosed. A method for controlling access to at least one AI model according to an aspect of the present disclosure includes refining information available for the at least one AI model based on at least one of access rights or access control policies to obtain filtered data for the at least one AI model; and obtaining output data of the at least one AI model based on the filtered data, and the filtered data may include at least one of learning information for the at least one AI model or request information for the at least one AI model.

### CROSS-REFERENCE TO RELATED APPLICATIONS

The present application claims priority to Korean Patent Application No. 10-2023-0088090 filed on Jul. 7, 2023, and Korean Patent Application No. 10-2023-0107530 filed on Aug. 17, 2023, the contents of which are hereby incorporated by reference in its entirety.

### TECHNICAL FIELD

The present disclosure relates to a method, a device, a computer program and a recording medium for controlling an artificial intelligence model, and more particularly, relates to a method, a device, a computer program and a recording medium for performing access control based on an access right for an artificial intelligence model.

### BACKGROUND ART

Artificial intelligence (AI) corresponds to a technology that implements a human thinking ability such as inference, perception, understanding, etc. through a computer. Machine learning (ML) refers to a structure that outputs a new conclusion through analysis, processing, etc. of new input data through learning or training of deriving a conclusion based on data. For example, a deep neural network (DNN) may be used as a way to implement ML. In other words, ML corresponds to a partial region of AI. An AI model in the present disclosure includes a model based on various methods including ML. For example, an AI model may perform a role including generating new data, making a decision, etc. based on learned data.

Information input to an AI model may include training data provided in a training step, analysis target data provided in reasoning step after training, etc. In the existing AI model, there is no limit to such input information. For example, confidential information or sensitive information, etc. may be also input to an AI model in a training or inference step without being distinguished from other information. Accordingly, confidential information, sensitive information, etc. may be provided as it is or information processed based on confidential information or sensitive information may be provided as output data of an AI model. To prevent this problem, control over information accessed by an AI model is required, but a detailed method therefor has not been prepared yet.

### DISCLOSURE

### Technical Problem

A 2echnical problem of the present disclosure is to provide a method for controlling access to input data of an AI model based on an access right.

The technical objects to be achieved by the present disclosure are not limited to the technical matters mentioned above, and other technical objects not mentioned are to be clearly understood by those skilled in the art from the following description.

### Technical Solution

A method for controlling access to at least one AI model according to an aspect of the present disclosure includes refining information available for the at least one AI model based on at least one of access rights or access control policies to obtain filtered data for the at least one AI model; and obtaining output data of the at least one AI model based on the filtered data, and the filtered data may include at least one of learning information for the at least one AI model or request information for the at least one AI model.

It is to be understood that the foregoing summarized features are exemplary aspects of the following detailed description of the present disclosure and are not intended to limit the scope of the present disclosure.

### Technical Effects

According to the present disclosure, a method for controlling access to input data of an AI model based on an access right may be provided.

The advantageous effects of the present disclosure are not limited to the foregoing descriptions, and additional effects will become apparent to those having ordinary skill in the pertinent art to the present disclosure based upon the following descriptions.

### DESCRIPTION OF DIAGRAMS

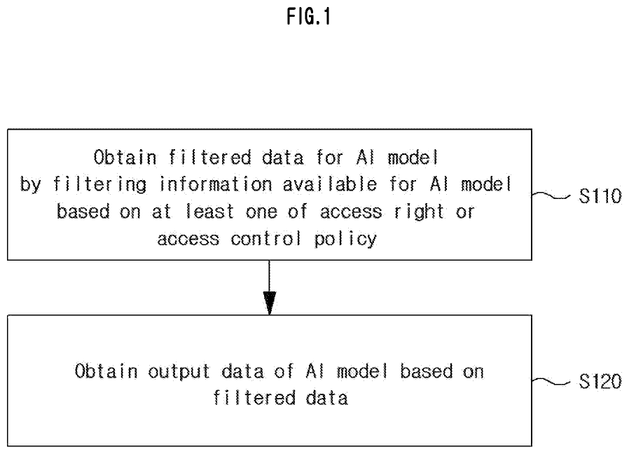

FIG. 1 is a flow chart showing an access control method of an AI model according to the present disclosure.

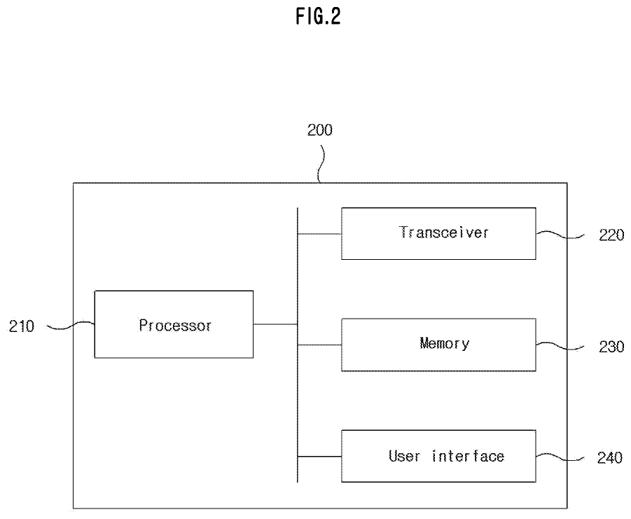

FIG. 2 is a block diagram conceptually showing a configuration of a device including an access control function for an AI model according to the present disclosure.

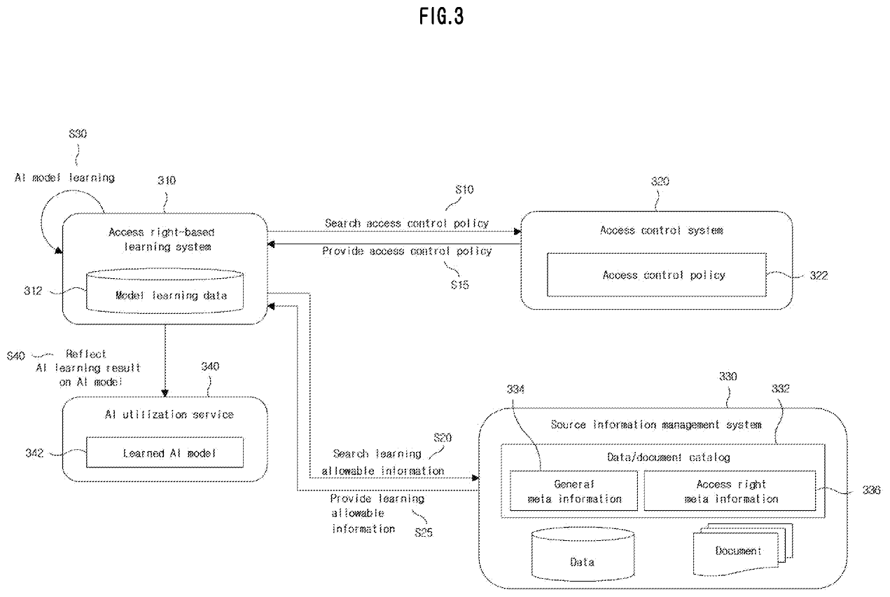

FIG. 3 is a diagram for describing an example of an access right-based AI learning system according to the present disclosure.

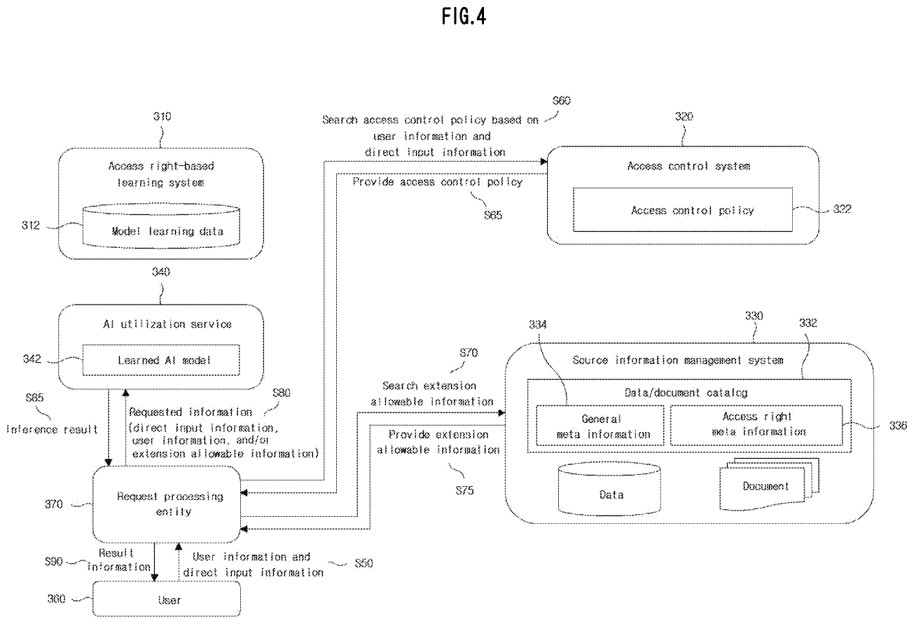

FIG. 4 is a diagram for describing an example of an access right-based AI request processing system according to the present disclosure.

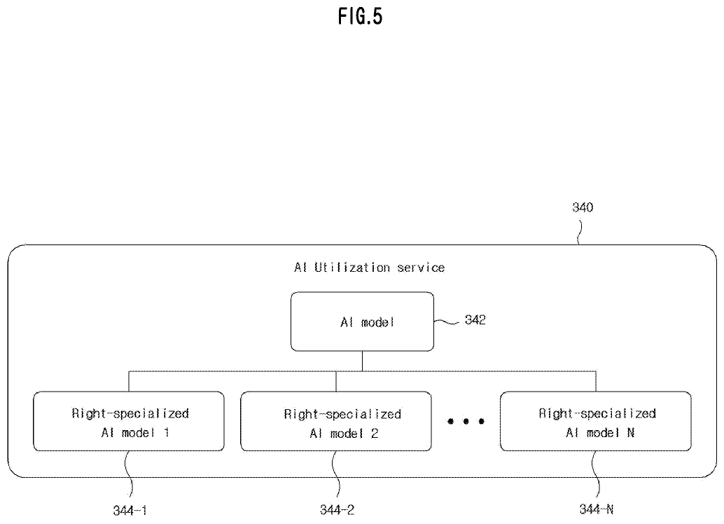

FIG. 5 is a diagram for describing an example of a hierarchical access control system through an access right-specialized AI model according to the present disclosure.

### MODE FOR INVENTION

Hereinafter, embodiments of the present invention will be described in detail so that those skilled in the art can easily carry out the present invention referring to the accompanying drawings. However, the present disclosure may be embodied in many different forms and is not limited to the embodiments described herein.

In the following description of the embodiments of the present invention, a detailed description of known functions and configurations incorporated herein will be omitted when it may make the subject matter of the present disclosure unclear. Parts not related to the description of the present disclosure in the drawings are omitted, and similar parts are denoted by similar reference numerals.

In the present disclosure, when an element is referred to as being “connected”, “coupled”, or “accessed” to another element, it is understood to include not only a direct connection relationship but also an indirect connection relationship. Also, when an element is referred to as “containing” or “having” another element, it means not only excluding another element but also further including another element.

In the present disclosure, the terms “first”, “second”, and so on are used only for the purpose of distinguishing one element from another, and do not limit the order or importance of the elements unless specifically mentioned. Thus, within the scope of this disclosure, the first component in one embodiment may be referred to as a second component in another embodiment, and similarly a second component in one embodiment may be referred to as a second component in another embodiment.

In the present disclosure, components that are distinguished from one another are intended to clearly illustrate each feature and do not necessarily mean that components are separate. That is, a plurality of components may be integrated into one hardware or software unit, or a single component may be distributed into a plurality of hardware or software units. Accordingly, such integrated or distributed embodiments are also included within the scope of the present disclosure, unless otherwise noted.

In the present disclosure, the components described in the various embodiments do not necessarily mean essential components, but some may be optional components. Accordingly, embodiments consisting of a subset of the components described in one embodiment are also included within the scope of this disclosure. Also, embodiments that include other components in addition to the components described in the various embodiments are also included in the scope of the present disclosure.

The definitions of the terms used in the present disclosure are as follows.

An AI model may be defined through a training or learning process. Data used for training or learning may be referred to as training data or learning data. Training or learning may include pre-training and fine tuning.

Pre-training refers to training that strengthens a general capability of an AI model. Pre-training includes a training or learning process that repeats a process of deriving a result from a large amount of data with a goal of improving the overall capability of an AI model. The present disclosure does not limit a training or learning method (e.g., supervised learning or unsupervised learning), and examples of the present disclosure may be applied to a training or learning process in various method.

Fine tuning refers to training that strengthens a specific capability of an AI model. It includes a learning process of repeating a process of deriving a result from learning data which is a small amount compared to pre-training but has a specific purpose. Fine tuning may be also referred to as transfer learning. For example, an AI model for a special purpose may be obtained by reproducing a general AI model that pre-training is completed (i.e., a pre-trained model) and performing fine tuning through data suitable for other specific purposes per reproduced model. Learning data for fine tuning may be referred to as specific learning data by being distinguished from pre-training data for pre-training.

When requested information is input to an AI model that training or learning based on pre-training data and/or specific learning data is completed, result information accordingly may be derived and this process is referred to as an inference process of an AI model. Requested information commonly refers to information provided to an AI model in order to obtain result information expected by a user of an AI model. Requested information may include direct input information, additional input information, etc.

Direct input information refers to input information directly provided or requested by a user among analysis target data provided for inference of an AI model.

Additional input information refers to input information additionally provided or requested to perform inference for direct information. Additional input information may include relevant detailed information that complements direct input information on an AI model, prompt information (e.g., a text included in requested information) configured in a format that an AI model understands information for guiding an operation direction of an AI model and others.

A keyword may be used for in-context learning or one-shot/few-shot learning of an AI model, and an AI model may (temporarily) have an ability to learn and summarize the contents of a keyword or imitate and reason it. Here, a training process or a learning process including pre-training and fine tuning may be referred to as a process of changing or updating a characteristic itself of an AI model or a parameter set of an AI model. In distinction from this, keyword-based learning corresponds to a phenomenon in which a characteristic itself of an AI model is not changed and keyword information is temporarily used only in an inference process of result information for related requested information.

FIG. 1 is a flow chart showing an access control method of an AI model according to the present disclosure.

In S110, a device including an access control function for an AI model may filter information available for at least one AI model based on at least one of an access right or an access control policy to obtain filtered data which may be input to at least one AI model. For example, an access control policy may be determined based on an access right. In addition, information available for an AI model may include information that does not require an access right (or is accessible to everyone) or information that requires an access right (or is accessible only to its part). For example, information available for an AI model may include various forms of source information such as source data, a source document, etc.

For example, filtered data may include pre-training data for an AI model. For example, filtered data may include specific learning data relevant to fine tuning for an AI model. For example, filtered data may include requested information for an AI model (e.g., knowledge information or a keyword, etc.). Additionally or alternatively, filtered data may include at least one of pre-training data, specific learning data or requested information (e.g., knowledge information or a keyword, etc.).

For example, learning information may correspond to learning allowable information associated with specific access right meta information among information available for an AI model. Specific access right meta information may be access right meta information corresponding to an access right and/or an access control policy. Accordingly, a learning process for at least one AI model may be performed based on learning information. For example, learning allowable information may be applied to pre-training and/or fine tuning learning for at least one AI model.

For example, requested information may be input to at least one AI model that learning is completed as above (e.g., a right-specialized AI model), and output data may be obtained through an inference process based on requested information. Alternatively, requested information may be input to at least one AI model (e.g., a generic AI model) that pre-training and/or fine tuning is completed based on general learning information not included in filtered data, and output data may be obtained through an inference process based on requested information. Alternatively, requested information may be input to at least one right-specialized AI model and at least one generic AI model, and output data may be obtained through an inference process based on requested information.

Requested information may include user information, information directly input by a user and/or additional input information. Among them, additional input information, among information available for an AI model, may correspond to extension allowable information associated with access right meta information corresponding to an access control policy or may correspond to information extracted or processed from such extension allowable information. An access control policy involved in determining extension allowable information may be determined based on user information and/or information directly input by a user. For example, additional input information may include knowledge information related to data directly input by a user, a keyword generated based on data directly input by a user, etc.

At least one AI model may include at least one generic AI model and/or at least one right-specialized AI model. For example, a different specialized AI model may correspond to an AI model trained based on a different access right or access control policy.

For example, training information of an AI model may be input to one right-specialized AI model or a plurality of right-specialized AI models. Requested information for an AI model may be input into one right-specialized AI model or a plurality of right-specialized AI models.

In S120, a device including an access control function for an AI model may acquire output data of at least one AI model based on filtered data (i.e., data filtered based on at least one of an access right or an access control policy). \

For example, output data of an AI model based on filtered data may include data output by an AI model that a training process is completed based on training data filtered based on an access right and/or an access control policy. Here, requested information input to an AI model that training is completed based on filtered training data may include requested information filtered based on an access right (and/or an access control policy) and/or requested information to which an access right (and/or an access control policy) is not applied.

For example, output data of an AI model based on filtered data may include data output through an inference processing input information including requested information filtered based on an access right and/or an access control policy for a trained AI model. Here, a trained AI model to which filtered requested information is input may include an AI model trained by using filtered training data and/or training data with an open right (i.e., an access right and/or an access control policy is not applied or necessary).

For example, output data of an AI model based on filtered data may include data output through an inference process using input information including requested information filtered based on an access right and/or an access control policy for an AI model that a training process is completed based on training data filtered based on an access right and/or an access control policy. For example, an AI model trained by using filtered training data may include at least one right-specialized AI model. Requested information input to at least one right-specialized AI model may be classified or filtered based on an access right and/or an access control policy and delivered or routed to a corresponding right-specialized AI model. For example, as a result of access right-based classification or filtering for requested information, it may be decided exclusively to deliver requested information by using only one appropriate right-specialized AI model, and when there are multiple appropriate right-specialized AI models, requested information may be commonly delivered by using corresponding right-specialized AI models.

Output of at least one AI model may be integrated and provided by one AI model of them (e.g., a generic AI model). Alternatively, output of at least one AI model may be output (without being integrated) as output data of each AI model.

FIG. 2 is a block diagram conceptually showing a configuration of a device including an access control function for an AI model according to the present disclosure.

A device 200 may include a processor 210, a transceiver 220, a memory 230, and a user interface 240. The processor 210, the transceiver 220, the memory 230, and the user interface 240 may exchange data, requests, responses, commands, or the like through an internal communication network.

The processor 210 may control operations of the transceiver 220, the memory 230, and the user interface 240. The processor 210 may perform operations according to the present disclosure. In addition, the processor 210 may control the overall operation of the device 200 including components of the device 200 not shown in FIG. 2.

The transceiver 220 may perform a function of a physical layer that exchanges data with other entities through wired or wireless communication.

The memory 230 may store information generated or processed by the processor 210, software, operating system, application related to the operation of the device 200, or the like, and may include components such as a buffer. In addition, the memory 230 may store data, or the like according to the present disclosure. In addition, the memory 230 may include a storage (e.g., a hard disk, etc.) for temporarily storing or maintaining data.

The user interface 240 may detect operations, inputs, or the like of a user for the device 200 and transport it to the processor 210, or may output the processing result of the processor 210 in a way that the user may recognize.

A processor 210 may be configured to perform an operation corresponding to each step in FIG. 1 or may include a module that performs each step in FIG. 1.

Hereinafter, specific examples of the present disclosure will be described.

The existing AI models do not have a structure that can consider a right to access learning data available for an AI model. Accordingly, it is not possible to control an AI model's access to unauthorized information, and a problem may occur in which an AI model provides/outputs processed information based on unauthorized information or unauthorized information itself to a requester.

According to the present disclosure, a data access control method of an AI model is newly defined to consider an access right to information available for an AI model. Accordingly, it is possible to prevent an AI model from leaking information to a requester without an access right and solve an access control problem in a use method including an AI model.

As described above, data input to an AI model may largely include learning information used for learning and requested information used for inference. Learning information input to an AI model may include pre-training data for pre-training and/or specific learning data for fine tuning, etc. In addition, requested information input to an AI model may include a keyword, etc.

In the present disclosure, by applying access control to information input in a learning process and/or an inference process of an AI model (i.e., refining learning information and/or requested information), access control of an AI model may be performed as a result. In other words, filtered data may be obtained based on access control for a variety of information input to an AI model (e.g., pre-training data, specific learning data, requested information, etc.) and output data of an AI model may be obtained based on filtered data.

An access control system is a system that may process information available for an AI model and extract necessary information. This system may also filter and provide only data that may be used as learning information and requested information based on an access control policy linked to information available for an AI model.

An AI model is an artificial intelligence model learned based on learning information. In inference, requested information is received to generate output data suitable for the purpose of a model. Requested information used for inference may include data directly input by a user, and in addition, as data automatically collected by an AI model, only data allowed by an access control system may be selectively included according to a user's right.

An access control policy is defined as an access control policy for information which will be used by an AI model as input. An access control policy reflects an access right to information available for an AI model and may be determined to process only information to which an AI model has an access right.

Requested information generation and processing refers to an operation which extracts allowed information from information available for an AI model according to an access control policy, extracts or processes it into requested information including a keyword, etc. and reflects it on input data of an AI model or an entity which performs such an operation.

An access rights-based AI learning system may provide learning information which may be used for pre-training and/or fine-tuning of an AI model based on information whose right is open to all AI model accessors among information available for an AI model. For example, among information available for an AI model, information whose right is open to all AI model accessors may be utilized by an AI model without going through an access control system.

For example, without applying access control related to temporary learning based on requested information (e.g., a keyword), an AI model trained based on access control may be applied. For example, for information with an open right, access control to a keyword is not applied to ensure that an AI model may utilize it without going through an access control system, and an AI model may be trained in an access control-based pre-training and/or fine-tuning method to ensure that an access control means may be directly included in an AI model. For example, in an example of a right-specialized AI model in FIG. 5 described later, each right-specialized AI model may correspond to a model which is trained through pre-training and/or fine-tuning using learning information per access right.

Processing of open right information may include collecting and processing information whose right is open to all AI model accessors among information available for an AI model and managing it as learning data which may be used for general learning and/or fine-tuning learning of an AI model.

According to embodiments of the present disclosure, a system for controlling access to knowledge of an AI model configured with an access control system, an artificial intelligence model and an access control policy may be provided.

For example, an access control system may process information available for an AI model, extract necessary information and convert it into a keyword.

For example, an access control policy may filter information which will be used as requested information (e.g., a keyword) based on a right to information available for an AI model.

For example, an access control method may include filtering and extracting necessary information from information available for an AI model, converting it into requested information (e.g., a keyword) and transmitting it to an AI model.

Additionally or alternatively, an access control system described above may be configured to improve an AI model by learning an AI model using information available for an AI model that is accessible to everyone according to an access control policy.

For example, a fine-tuning system may use access control information to improve knowledge of an AI model by utilizing information available for an AI model that is accessible to everyone.

For example, information available for an AI model that is accessible to everyone may be utilized to collect and process information needed for fine-tuning learning of an AI model.

FIG. 3 is a diagram for describing an example of an access right-based AI learning system according to the present disclosure.

An access right-based learning system 310 may maintain, manage and update model learning data 312. Model learning data 312 may include pre-training data for pre-training and/or specific learning data related to fine-tuning, etc. described above.

An access control system may maintain, manage and update an access control policy 322. For example, an access control policy 322 may include access subject information based on requester information of an AI model. For example, access subject information may include all or part of requester identification information, group identification information to which a requester belongs, right level information held by a requester, etc.

A source information management system 330 may maintain, manage and update data and/or a document (hereinafter, data/a document) and maintain, manage and update a catalog 332 for data/a document. A data/document catalog 332 may include general meta information 334 and access right meta information 336. For example, general meta information 334 may include a creation time, a modification time, an access time, a size, a title, a storage, an encryption state, a location, etc. For example, access right meta information 336 may include all or part of a creator, a modifier, an owner, a manager, a management group, a right identifier, a right level, a security level, other identification information, etc. Access right meta information 336 may be defined per individual data/document or per data/document group.

An AI utilization service 340 may include an AI model 342.

An access right-based learning system 310 may query an access control system 320 for an access control policy that AI learning is allowed S10 and an access control system 320 may provide an access control policy (e.g., access subject information) to an access right-based learning system 310 S15.

An access right-based learning system 310 may determine whether to allow access to data/a document individually or per group based on access right meta information 336 stored in a source information management system 330 and an access control policy 322 obtained from an access control system 320. For example, an access right-based learning system 310 may search for information that AI learning is allowed in a source information management system 330 S20 and a source information management system 330 may an access right-based learning system 310 with learning allowable information S25.

For example, among documents stored in a source information management system 330, documents associated with access right meta information 336 including a group identifier “ABC” may be accessible to group members belonging to a group identifier “ABC” among access subject information. For example, among data stored in a source information management system 330, documents associated with access right meta information 336 including a right level “medium” and “low” may be accessible to a user with a right level of “medium” among access subject information.

Each of access right meta information 336 and an access control policy 322 may be configured with at least one element or a set of attributes. For example, access to data/a document associated with access right meta information 336 that satisfies a standard in various aspects required by an access control policy 322 may be allowed. As such, whether to allow access to source information may be determined based on whether all of a plurality of elements/attributes are satisfied.

Learning data that access of an access right-based learning system 310 is allowed may correspond to learning data filtered based on an access right or an access control policy. Filtered learning data may be added or updated to model learning data 312. Based on learning data maintained in model learning data 312, learning (e.g., pre-training and/or fine-tuning learning) for an AI model may be performed.

For example, specific learning information related to pre-training data and/or fine-tuning included in model learning data 312 may include information determined to be accessible based on an access control policy and access right meta information.

For example, specific learning information related to pre-training data and/or fine-tuning included in model learning data 312 may include reference learning data. For example, reference learning data may include information allowed to everyone without any limit to an access right (i.e., information with an open right). Accordingly, an AI model trained based on general learning information to which access control is not applied may be applied.

For example, specific learning information related to pre-training data and/or fine-tuning included in model learning data 312 may include reference learning data (e.g., information with an open right) and information determined to be accessible based on an access control policy and access right meta information.

An access right-based learning system 310 may repeatedly perform a learning process (e.g., pre-training and/or fine-tuning) for an AI model based on model learning data 312 S30. An AI learning result, a result of repetitive performance of a learning process, may be reflected on an AI model S40 to construct a learned AI model 342. Accordingly, an AI utilization service 340 may provide result information for requested information from a user based on an learned AI model 342. Here, when a learned AI model 342 is learned based on learning data processed or filtered based on an access control policy and/or an access right among source information (e.g., pre-training data and/or specific learning data related to fine-tuning), a result based on filtered learning data may be output. Alternatively, when a learned AI model 342 is learned based on information on an open right that an access control policy and/or an access right is not required among source information, a result may be output based on requested information filtered based on access control.

FIG. 4 is a diagram for describing an example of an access right-based AI request processing system according to the present disclosure.

In FIG. 4, it may be assumed that a learned AI model 342 included in an AI utilization service 340 is an AI model that a learning process (e.g., pre-training and/or fine-tuning) is completed by utilizing data filtered based on an access right and/or an access control policy as learning data as in an example of FIG. 3. Alternatively, a learned AI model 342 may be an AI model which is pre-trained and/or fine-tuned based on general data with an open right (i.e., data that a right is not required), not a right-specialized AI model (e.g., an AI model in which fine-tuning learning is completed based on data filtered based on an access right and/or an access control policy).

User information and direct input information may be provided to a request processing entity 370 from a user 360 S50. For example, user information may include information such as user identification information, identification information of a group to which a user belongs, a user's right level, a user's security level, etc. For example, direct input information may correspond to a set of information provided directly by a user to obtain result information expected by a user through an AI model.

A request processing entity 370 may query an access control policy based on user information and direct input information to an access control system 320 S60 and an access control system 320 may provide a request processing entity 370 with a corresponding access control policy S65. For example, an access control policy 322 may include access subject information matching user information. For example, an access control policy 322 may include a keyword list corresponding to a keyword extracted from direct input information. For example, an access control policy 322 may also include access subject information and a keyword list based on user information and direct input information. For example, when direct input information is “Please prepare a marketing report for this year,” a keyword list may correspond to “this year,” “marketing,” and “report.”

A request processing entity 370 may determine whether to allow individual/group access to data/a document based on access right meta information 336 stored in a source information management system 330 and an access control policy 322 obtained from an access control system 320. For example, a request processing entity 370 may search information allowed to be provided as additional input information to an AI model in a source information management system 330 S70 and a source information management system 330 may provide extension allowable information to a request processing entity 370 S75. For example, extension allowable information may correspond to a document/data associated with access right meta data that matches an access control policy (e.g., access subject information and/or a keyword list) corresponding to user information and/or direct input information. Alternatively, information extracted or processed from a document/data corresponding to such extension allowable information (e.g., knowledge information that supplements direct input information as detailed data related to a keyword of direct input information and/or a keyword which may be used for in-context learning, etc. of an AI model) may be generated in a source information management system 330 and provided to a request processing entity 370.

For example, it shows that access subject information is an abc team member belonging to a ABC team, and for “this year” “marketing” and “report”, an example of a keyword list described above, a document or data searched as extension allowable information may include a 2023 market trend report, a 2022 ABC Team report sample document, etc. Accordingly, information extracted or processed based on such a search result may include, for example, data such as a market share, sales, the number of customers, the number of potential customers, etc. in 2023, ABC Team marketing report form information, etc., which may be provided to a request processing entity 370 as extension allowable information.

This keyword-based search result is an example of extension allowable information and does not limit a scope of the present disclosure. For example, in the present disclosure, extension allowable information may include information searched/processed/generated in various ways based on information in a database such as a source information management system 330. For example, a search method may include a method of searching a document with an allowed access right (e.g., whether to allow an access right may be determined based on access right meta information 336) among documents contextually related to a keyword input by a user based on a keyword from a general database, and/or a method of searching based on an embedding vector value that is pre-processed, processed and stored in an AI model from a vector information database. For example, information processed by applying processing such as classification, conversion, extraction, indexing, weighting, etc. may be stored in advance for an obtained text and may be utilized to derive a search result. Context-based vector search may be also applied to a different language and have higher accuracy than keyword-based search in some cases, and context-based vector search and keyword-based search may be applied simultaneously. For a result searched through these various search methods (e.g., a searched document or part of a document (e.g., paragraph information)), a priority may be granted based on a relevance to information (or query) directly input by a user, and extension allowable information may be processed/generated by selecting or summarizing all or part of a search result according to a priority.

Additionally or alternatively, information (e.g., knowledge information, a keywords, etc.) extracted or processed by a request processing entity 370 from extension allowable information obtained from a source information management system 3300 may correspond to data filtered based on an access right or an access control policy.

Data filtered in this way may be provided as requested information (e.g., along with user information and direct input information) to a learned AI model 342 as additional input data S80. For example, in an example described above, when information directly input by a user is “Please prepare a marketing report this year,” request information may include “Please prepare a marketing report this year” which is direct input information, an abc team member of a ABC team which is user information and/or data such as a market share, sales, the number of customers, the number of potential customers, etc. in 2023 which is extension allowable information, ABC team marketing report form information, etc.

As described above, input information provided to an AI model from a request processing entity 370 based on access right-based control may be collectively referred to as requested information. An AI utilization service 340 may provide a request processing entity 370 with a result through an inference process performed based on requested information (e.g., user information, direct input information and/or access right control-based additional input information) through a learned AI model 342 S85.

A request processing entity 370 may provide an inference result obtained from an AI model as it is or after processing it to a user 380 as result information S90.

As in an example of FIGS. 3 and 4, access right-based AI model control according to the present disclosure may control or limit learning information input to an AI model in a learning process (e.g., pre-training and/or fine-tuning) of an AI model (e.g., pre-training data and/or specific learning data) and/or requested information input to an AI model in an inference process using an AI model (e.g., knowledge information and/or a keyword, etc.) to information to which access is allowed based on an access right.

Access right-based control for a learning process of an AI model (e.g., learning data for pre-training and/or fine-tuning) and access right-based control for an inference process of an AI model (e.g., a keyword among requested information) may be performed sequentially, independently or in parallel.

FIG. 5 is a diagram for describing an example of a hierarchical access control system through an access right-specialized AI model according to the present disclosure.

An example in FIG. 5 shows an example of a hierarchical access control method through N (N is an integer equal to or greater than 1) right-specialized AI models. An example in FIG. 5 shows an example of a higher layer (e.g., an AI model 342) and a lower layer (344-1, . . . , 344-N), but an AI model may be configured with at least three multi-layers.

An access right may be separated per AI model to configure an access right-specialized AI model. For example, right-specialized AI model 1 (344-1) may correspond to a first type of access right and right-specialized AI model N (344-N) may correspond to a N-th type of access right. As described above, an access right may be defined as a combination of one or a plurality of elements/attributes, so some elements/attributes of a different type of access right may be the same or different. Accordingly, an AI model that AI learning is completed in advance may be provided based on information (data/a document) allowed per access right. In addition, requested information allowed per access right (e.g., additional input information) may be provided as input to a corresponding right-specialized AI model.

For example, user information and direct input information provided by a user may correspond to one right-specialized AI model or one access control policy or may correspond to a plurality of right-specialized AI models or a plurality of access control policies. Accordingly, based on user information and direct input information (further, additional input information), inference result information thereof may be obtained by querying at least one corresponding AI model.

Based on a right-specialized AI model being provided, an AI model 342 may correspond to a generic AI model that prior AI learning is completed for the entire allowable information. An inference result through an AI model corresponding to various rights may be integrated or processed and provided through one generic AI model (e.g., an AI model 342) or may include a plurality of inference result information (i.e., information not integrated or processed) of a plurality of right-specialized AI models 344-1, . . . , 344-N.

Based on various examples of the present disclosure, a new effect may be achieved in which a result of an AI mode that matches a user's access right is provided through access right-based control for learning data and/or requested information that may not be expected in the existing AI model.

Although the exemplary methods of this disclosure are represented by a series of steps for clarity of explanation, they are not intended to limit the order in which the steps are performed, and if necessary, each step may be performed simultaneously or in a different order. In order to implement the method according to the present disclosure, other steps may be included to the illustrative steps additionally, exclude some steps and include remaining steps, or exclude some steps and include additional steps.

The various embodiments of the disclosure are not intended to be exhaustive of all possible combination, but rather to illustrate representative aspects of the disclosure, and the features described in the various embodiments may be applied independently or in a combination of two or more.

In addition, various embodiments of the present disclosure may be implemented by hardware, firmware, software, or a combination thereof. A case of hardware implementation may be performed by one or more application specific integrated circuits (ASICs), digital signal processors (DSPs), digital signal processing devices (DSPDs), programmable logic devices (PLDs), field programmable gate arrays (FPGAs), a general processor, a controller, a microcontroller, a microprocessor, or the like.

The scope of the present disclosure is to encompass software or machine-executable instructions (e.g., operating system, applications, firmware, instructions, or the like) by which operations according to method of various embodiments are executed on a device or a computer, and non-transitory computer-readable media executable on the device or the computer, on which such software or instructions are stored.

1. An access control method for at least one artificial intelligence (AI) model, the method comprising:
filtering information available for the at least one AI model based on at least one of an access right or an access control policy and acquiring filtered data for the at least one AI model; and
acquiring output data of the at least one AI model based on the filtered data,
wherein the filtered data includes at least one of learning information for the at least one AI model or requested information for the at least one AI model.

2. The method of claim 1, wherein:
the learning information corresponds to learning allowable information associated with access right meta information corresponding to at least one of the access right or the access control policy among the available information,
a learning process for the at least one AI model is performed based on the learning information.

3. The method of claim 2, wherein:
the learning allowable information is applied to fine-tuning learning for the at least one AI model.

4. The method of claim 2, wherein:
the access right meta information includes information on at least one of a creator, a modifier, an owner, a manager, a management group, a right identifier, a right level or a security level.

5. The method of claim 1, wherein:
the requested information is input to the at least one AI model learned based on the learning information included in the filtered data or at least one AI model learned based on general learning information not included in the filtered data,
the output data is acquired through an inference process based on the requested information.

6. The method of claim 1, wherein:
the requested information includes at least one of user information, direct input information or additional input information.

7. The method of claim 6, wherein:
the additional input information is based on extension allowable information associated with access right meta information corresponding to the access control policy among the available information,
the access control policy is based on at least one of the user information or the direct input information.

8. The method of claim 7, wherein:
the additional input information includes at least one of knowledge information related to the direct input information or a keyword generated based on the direct input information.

9. The method of claim 1, wherein:
the at least one AI model includes at least one of at least one generic AI model or at least one right-specialized AI model.

10. The method of claim 9, wherein:
each of a plurality of specialized AI models corresponds to a different access right or access control policy.

11. The method of claim 9, wherein:
the filtered data is input to one right-specialized AI model or a plurality of right-specialized AI models.

12. An access control device for at least one artificial intelligence (AI) model, the device comprising:
a transceiver;
a memory;
a user interface; and
a processor,
wherein the processor is configured to:
filter information available for the at least one AI model based on at least one of an access right or an access control policy, acquire filtered data for the at least one AI model and store it in the memory; and
acquire output data of the at least one AI model based on the filtered data and store it in the memory,
wherein the filtered data includes at least one of learning information for the at least one AI model or requested information for the at least one AI model.

13. A non-transitory computer-readable recording medium storing a computer program for executing a method at a computer according to claim 1.
